(19) United States
(12) Patent Application Publication
(10) Pub. No.: US 2005/0033515 A1
(43) Pub. Date: Feb. 10, 2005

(54) Wireless personal tracking and navigation system

(75) Inventor: Stephen O. Bozzone, Lauderhill, FL (US)

Correspondence Address: CARDINAL LAW GROUP, LLC, SUITE 2000, 1603 ORRINGTON AVENUE, EVANSTON, IL, 60201, US

(73) Assignee: MOTOROLA, INC.

(21) Appl. No.: 10/635,963

(22) Filed: Aug. 7, 2003

(51) Int. Cl. G01C 21/26

(52) U.S. Cl. 701/214; 701/213; 342/357.07

(57) ABSTRACT

The invention provides a personal tracking system comprising a wireless communication device, a pedometer electrically coupled to the wireless communication device, and an electronic compass operably positioned with respect to the pedometer. The wireless communication device receives readings from the pedometer and the electronic compass to provide position information. A method of tracking a location of a person, a system for tracking the location of a person, and an electronic module for a personal tracking system are also disclosed.

### FIELD OF THE INVENTION

This invention relates generally to personal navigation and tracking systems. More specifically, the invention relates to a personal tracking system comprising a pedometer and an electronic compass electrically coupled to a wireless communication device such as a cell phone or a mobile radio.

### BACKGROUND OF THE INVENTION

Position detection systems for motor vehicles and other mobile objects often use global positioning system (GPS) technology to detect the location of an object. In addition, position detectors have been developed recently for detecting the position of the vehicle that augment the GPS readings. For example, some self-contained navigational GPS systems for vehicles have additional integrated speed and directions sensors such as gyroscopes that help detect the direction for a predetermined distance or time and the distance traveled during the period when GPS readings are not valid. Measurements of distance in a detected direction are added cumulatively to the starting-point position measurement to determine the current position.

Portable position detectors based on GPS need to receive GPS timing and signaling information from more than one GPS satellite in order to calculate the location where the receiver is located. Unfortunately, it is common for manmade structures such as buildings and natural structures such as mountains and dense woods to block GPS satellite signals from a portable detector. GPS detectors are often ineffective indoors.

Current portable navigational tracking systems can be successful in an open field or similar environments. Researchers have developed portable position-detection systems that make use of various components including a GPS receiver, magnetic compass, pedometer, accelerometer, gyroscopes, and data from previous terrain readings. For example, Matsuoka and others describe a device with a pedometer, a geomagnetic sensor, and an acceleration sensor to detect the position of a person in “Portable Position Detector and Position Management System,” U.S. Pat. No. 6,546,336 issued Apr. 8, 2003. Readings from the pedometer are used to correlate foot motion to the number of steps taken and the distance traveled.

Expensive and complex systems that have been proposed for personal inertial navigation systems (PINS) use multiple axis accelerometers and gyroscopes to determine the motion of a body of a person and to compute the location of the body based on acceleration and angular rotation information.

A navigation and position detector for determining and indicating the position of a pedestrian might also include a computer memory, an input device, and a display device as described in “Golf Navigation Appliance,” Talkenberg et al., U.S. Patent Application 2002/0038178 published Mar. 28, 2002. The method for determining the position of the walker with this navigation appliance includes measuring acceleration values using a motion sensor arranged on a pedestrian; storing in a memory device the measured acceleration values over a time period; and calculating the walking speed and/or distance walked for the user using an estimation model.

Besides devices that determine the longitudinal/latitudinal position of a person, there are other products have been developed to give feedback to walkers and runners on their speed, distance, calorie burn and heart rate. For example, a monitor that wraps around the chest measures the heart rate while an accelerometer that clips to a shoelace measures each stride. The collected speed, distance and heart-rate data are sent via a wireless link to the display of a wristwatch-like computer device. The performance data can be uploaded to the Internet for real-time monitoring and logging through a wired connection with a personal computer or a wireless connection with a mobile phone. Ohlenbush and others disclose a system and associated methods that use at least one sensor to detect and measure the stride of a walker or runner in “Monitoring Activity of a User in Locomotion on Foot,” U.S. Pat. No. 6,493,652 issued Dec. 10, 2002.

There are a number of beneficial applications for personal inertial navigation and tracking systems. For example, an on-foot personal inertial navigation system can benefit the person with the device directly by providing navigational information in, for example, a heavily forested or deep valley area. Applications for personal inertial tracking systems include the remote monitoring of people such as prisoners, workers in higher-risk work areas, and patients who are prone to wander and get lost.

Personal navigation and tracking systems need to be small, lightweight, low powered, and accurate in environmental conditions where GPS signals cannot be received. The systems should have options for navigational aid to be generated locally and provided to the user or to others for remote tracking of the user. A more desirable system would have a communication link from which an external system or others remote from the wearer could know immediately the movements of the wearer. What is desired therefore, is an inexpensive system and method for tracking and providing navigational aid to individuals, augmenting a global positioning system when needed, thereby overcoming the deficiencies and obstacles of other systems described above.

### SUMMARY OF THE INVENTION

One aspect of the invention provides a personal tracking system including a wireless communication device, a pedometer electrically coupled to the wireless communication device, and an electronic compass operably positioned with respect to the pedometer. The wireless communication device receives readings from the pedometer and the electronic compass to provide position information.

Another aspect of the invention is a method of tracking a location of a person. The method comprises the steps of receiving pedometer data from a pedometer, receiving heading information from an electronic compass, determining the location of the person based on the pedometer data and the heading information, and sending a position information message block from a wireless communication device. The position information message block comprises the determined location.

Another aspect of the invention is a system for tracking a location of a person, comprising means for receiving pedometer data, means for receiving heading information, means for determining the location of the person based on the pedometer data and the heading information, and means for sending a position information block with the determined location from a wireless communication device.

Another aspect of the invention is an electronic module for a personal tracking system. The module comprises a controller, a wireless transceiver operably connected between the controller and a pedometer, an electronic compass electrically coupled to the controller, and a wired connection to allow interfacing with a wireless communication device. Position information is determined based on readings from the pedometer and the electronic compass and provided to the wireless communication device via the wired connection.

The present invention is illustrated by the accompanying drawings of various embodiments and the detailed description given below. The drawings should not be taken to limit the invention to the specific embodiments, but are for explanation and understanding. The detailed description and drawings are merely illustrative of the invention rather than limiting, the scope of the invention being defined by the appended claims and equivalents thereof. The foregoing aspects and other attendant advantages of the present invention will become more readily appreciated by the detailed description taken in conjunction with the accompanying drawings.

### BRIEF DESCRIPTION OF THE DRAWINGS

Various embodiment of the present invention are illustrated by the accompanying figures, wherein:

FIG. 1 illustrates a personal tracking system, in accordance with one embodiment of the current invention;

FIG. 2 is a block diagram of a system for tracking a location of a person, comprising an electronic module for a personal tracking system, in accordance with one embodiment of the current invention; and

FIG. 3 is a flow diagram of a method for tracking a location of a person, in accordance with one embodiment of the current invention.

### DETAILED DESCRIPTION OF THE PRESENTLY PREFERRED EMBODIMENTS

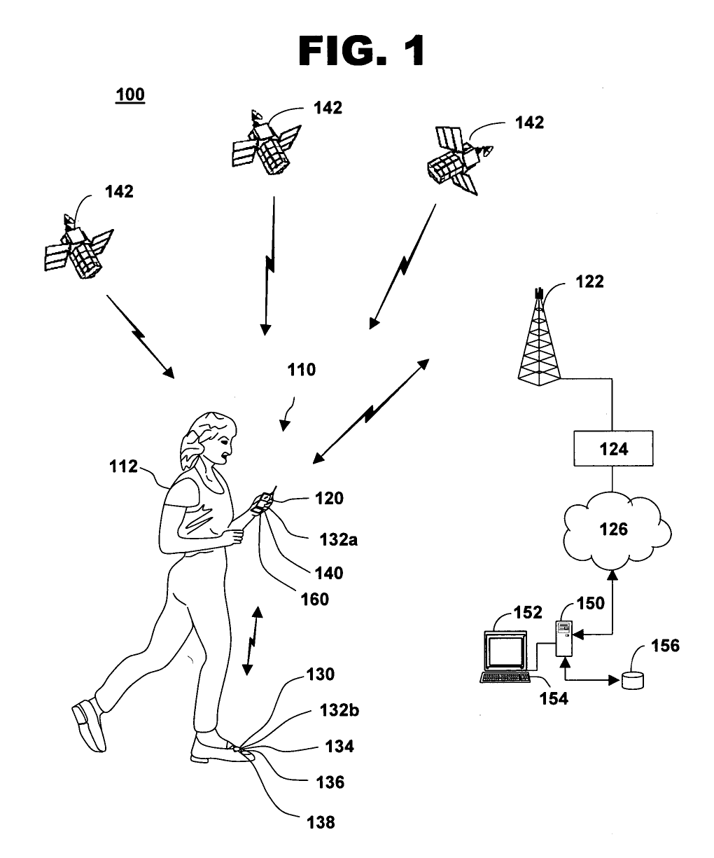

FIG. 1 shows an illustration of a personal tracking system, in accordance with one embodiment of the present invention at 100. Personal tracking system 110 comprises a wireless communication device 120, a pedometer 130 electrically coupled to wireless communication device 120, and an electronic compass 136 operably positioned with respect to pedometer 130. Readings from pedometer 130 and electronic compass 136 are received by wireless communication device 120 to provide position information. The position information may be used, for example, to determine the location of a person or user 112 inside a building, underground, between tall buildings or in other places where global positioning system (GPS) data is not reliable or not obtainable.

Wireless communication device 120 comprises, for example, a cell phone such as a CDMA, TDMA, GSM or multi-band phone, a mobile radio, an integrated digital enhanced network (iDEN) phone, a wireless network device for a LAN or WLAN, a PDA, or any phone or mobile radio capable of transmitting and receiving packet data. In one example, wireless communication device 120 is a cell phone with a display and an input device for selecting operational modes and viewing results. In another example, wireless communication device 120 is a mobile radio with a display and a walkie-talkie for relatively short-range communication that allows personal tracking and navigation in addition to voice communications. In another example, wireless communication device 120 is an iDEN radio equipped with a GPS unit 140 for determining the location of the radio and user 112 when GPS satellite data is available. Wireless communication device 120 may be, for example, attached to a person's waist, carried in a person's hand, or otherwise coupled to the body of user 112. Wireless communication device 120 may be connected, for example, by one or more wires to pedometer 130 or wirelessly connected to pedometer 130 with a pair of wireless transceivers 132a and 132b.

Pedometer 130, often attached to the shoe, foot, ankle or leg of user 112, contains, for example, at least one single-axis accelerometer 134 such as a piezoelectric accelerometer or a silicon-based micromachined accelerometer. Accelerometer 134 provides acceleration and deceleration signals corresponding to motion changes of the foot as user 112 ambulates, so that the current position can be determined with respect to a previous position or a reference location by calculating, for example, the number of steps or paces taken and the distance between steps. Pedometer 130 may comprise additional accelerometers 134 to determine, for example, changes in height or deviations from a straight line.

Pedometer 130 may contain an electronic compass 136 such as a calibrated magnetometer to determine heading information. Electrical signals from electronic compass 136 may be used to ascertain, for example, if user 112 is traveling in a northern direction, southern direction, or any direction in between. Alternatively, electronic compass 136 may be mounted to wireless communication device 120 or to an electronic module 160 within wireless communication device 120. Electronic compass 136 may be mechanically coupled to wireless communication device 120, to an electronic module within or connected to wireless communication device 120, or to pedometer 130.

Pedometer 130 may be electrically coupled to wireless communication device 120 via a wired or a wireless link. For example, pedometer 130 may be electrically coupled to wireless communication device 120 in accordance with an IEEE 802.15.4 wireless protocol, a Bluetooth protocol, or other short-range wireless protocol capable of transferring position data between pedometer 130 and wireless communication device 120. Alternatively, pedometer 130 may be electrically connected to wireless communication device with a wired link such as a serial or parallel data link.

In some cases, elevation or altitude information is desired to aid in determining the location of user 112. For example, user 112 may walk through a large factory or office building where GPS data is unavailable. As user 112 goes up and down stairs, elevators or escalators, the floor upon which user 112 is located can be determined from altitude information. A barometer 138 provides barometric pressure information from which altitude or height can be determined. Barometric signals are received by wireless communication device 120 to provide altitude information. Barometer 138, located in pedometer 130, within electronic module 160, or within wireless communication device 120, is electrically coupled to wireless communication device 120 to provide altitude information.

Global positioning system (GPS) unit 140 may be electrically coupled to wireless communication device 120. GPS signals from GPS unit 140 provide a longitudinal coordinate and a latitudinal coordinate to wireless communication device 120 that can be used to determine position information when GPS satellite signals from GPS satellites 142 are available with sufficient signal strength.

Position information of user 112 may be sent to a server 150 from personal tracking system 110. Server 150 is in communication with wireless communication device 120 when position information and related command messages are to be transferred. For example, wireless communication device 120 may be connected to server 150 through a cellular antenna system 122, a cellular phone network 124, and a combination of wired and wireless networks 126. Position information is sent from wireless communication device 120 to server 150 in response to a position request. The position request may be generated, for example, from an application running on server 150 or within wireless communication device 120. The position request may be generated, for example, automatically within a prescribed time limit, semi-automatically when GPS data is no longer available or a GPS signal diminishes below a signal threshold, or manually when prompted by user 112.

Position information may be generated and displayed locally on wireless communication device 120. Alternatively, position information may be generated and displayed on a display 152 connected to a computer 154 such as a laptop or personal computer for logging or otherwise tracking user 112. Position or location information may be stored as desired in a memory 156 connected to server 150.

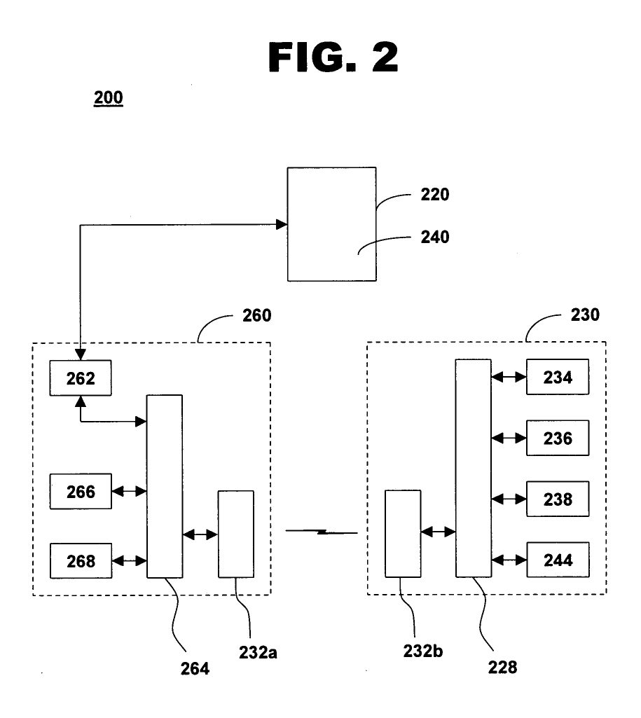

FIG. 2 shows a block diagram of a system for tracking a location of a person, in accordance with one embodiment of the present invention at 200. Location-tracking system 200 comprises a wireless communication device 220 such as a cell phone or a mobile radio and a pedometer 230, sometimes referred to as a foot pod.

In one embodiment, location-tracking system 200 comprises an electronic module 260 for a personal tracking system. Electronic module 260 comprises a controller 264 and a wireless transceiver 232a electrically connectable to a matching wireless transceiver 232b within pedometer 230. Wireless transceiver 232a in electronic module 260 may be operably connected to pedometer 230 via wireless transceiver 232b in pedometer 230 in accordance with an IEEE 802.15.4 wireless protocol, IEEE 802.11 wireless protocol, or other short-range wireless communication protocols. Electronic module 260 may be located within wireless communication device 220 or as an accessory module connectable to wireless communication device 220. In another embodiment, pedometer 230 is connected by a wired link to electronic module 260.

Electronic module 260 provides position information to wireless communication device 220. Electronic module 260 may comprise a wired connection to allow interfacing with wireless communication device 220. Position information is provided to wireless communication device 220 via the wired connection. Position information from electronic module 260 may be sent to wireless communication device 220 via a wired connection from within wireless communication device 220 or via a wired connection such as a serial port 262, which is external to wireless communication device 220. Serial port 262 may be located in electronic module 260 with a matching port located in wireless communication device 220 for sending and receiving data, messages, and position information.

Pedometer 230 comprises at least one accelerometer 234 for detecting one or more steps of a user and the distance between the steps. Pedometer 230 may comprise an electronic compass 236, such as a magnetometer, to provide heading information. Pedometer data received from pedometer 230 and heading information from electronic compass 236 are used to determine the position or location of the person or user. Electronic compass 236 may be electrically coupled to controller 264 via a wired or a wireless link.

Location-tracking system 200 may receive altitude information from a barometer 238 to determine the location of the person or user based on the altitude information. Barometer 238 may be comprised within pedometer 230. In one example, a controller 228 within pedometer 230 runs microcode to extract signals from accelerometer 234, electronic compass 236 and barometer 238, and to execute commands for transmitting position information to electronic module 260 or to wireless communication device 220. Controller 228 may calculate position information directly, or alternatively, send signal information to a controller either within electronic module 260 or wireless communication device 220 where the position or location information can be calculated. Alternatively, position or location information may be computed at an external server or a digital computing device connected to wireless communication device 220. Position information or signals from accelerometer 234, electronic compass 236, or barometer 238 within pedometer 230 may be stored in a memory 244 that is electrically coupled to controller 228, and may be extracted or inspected when desired.

For example, microcode running on controller 264 within electronic module 260 calculates the position of a user with respect to a reference or starting location based on the number of steps, distance between steps, and the direction of the steps. Starting or reference information may be provided, for example, from a GPS unit 240 located within wireless communication device 220 or from GPS unit 240 within electronic module 260. Alternatively, starting or reference information may be provided by voice or keypad input in response to an application running on wireless communication device 220.

In an alternative embodiment, electronic module 260 contains an electronic compass 266 from which heading information is obtained. Electronic compass 266 may be electrically coupled to controller 264 via a wired link. Pedometer data received from pedometer 230 and heading information from electronic compass 266 are used to determine the location of the person or user.

In another embodiment, electronic module 260 contains a barometer 268 electrically coupled to controller 264 from which altitude information is obtained. Altitude information is determined based on barometric signals from barometer 268. Location-tracking system 200 receives altitude information from barometer 268 to determine the location of the person or user based on the altitude information.

In another embodiment, electronic module 260 comprises GPS unit 240 (not shown). In this embodiment, GPS unit 240 is electrically coupled to controller 264. GPS signals from GPS unit 240 located in electronic module 260 provide a longitudinal coordinate and a latitudinal coordinate to controller 264.

A computer application may be loaded into and operated locally within wireless communication device 220 or electronic module 260 to track the location of a person or provide navigation services to a user. The application may be initiated automatically or manually at the request of the user. A personal reference location input may be received, for example, from an external server, from an application running locally, or in response to a user input. When the personal reference location input is received, the location of the person may be determined based on that personal reference location input. For example, GPS coordinate information is received from GPS unit 240, and the location of the person is determined based on the GPS coordinate information. Alternatively, a user can indicate via a voice or key entry his or her current location onto a map or a table displayed by wireless communication device 220, irregardless of whether or not GPS coordinate information is used.

Updates to the initial personal reference location may be made with additional GPS coordinates from GPS unit 240 or from pedometer 230 when GPS signals are not available. For example, updates for the location of the person may be made automatically or manually with an additional personal reference location input.

A position information message block comprising the determined location may be sent from wireless communication device 220 to, for example, a server or an application running on a portable digital assistant (PDA), laptop or personal computer connected to wireless communication device 220. The position information message block may be received at a server, and personal tracking information may be updated based on the received position information message block.

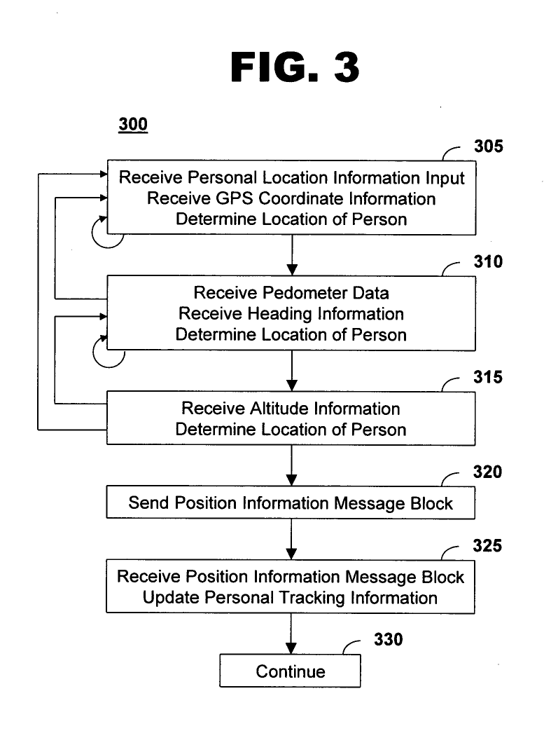

FIG. 3 shows a flow diagram of a method for tracking a location of a person, in accordance with one embodiment of the present invention at 300. Location tracking method 300 comprises various steps to track the position or location of a person.

To start, a person may attach a pedometer to a foot, shoe, ankle, or other suitable portion of the body. The pedometer is wired or wirelessly connected to a cell phone or radio. An electronic module with a short-range wireless link to the pedometer may be connected to the cell phone or radio as an accessory using, for example, a serial port in the cell phone or radio. The electronic module, cell phone, or radio has sufficient hardware and software to receive pedometer data and heading information from an electronic compass to determine the location of the person.

A personal reference location input is received, as seen at block 305. The personal reference location input may be received, for example, from an application running on a wireless communication device, from an application running on a remotely connected server, or from a manual input by a user of the system. The location of the person is then determined based on the personal reference location input. For example, a GPS unit coupled to the wireless communication device may be used to provide GPS coordinate information. After GPS coordinate information is received, the location of the person is determined based on the GPS coordinate information. In another example, a map of a building where the user is currently located may be displayed on the wireless communication device, and the user indicates his or her current location with a personal reference location input. The location of the person may be determined continuously when GPS coordinate information is readily available.

In situations where GPS coordinate information is not available or not reliable due to, for example, low signal strengths from the GPS satellites or the inability to obtain an accurate signal from within urban canyons, GPS coordinate information or other user-provided position or location information may be updated with local tracking information from a pedometer and an electronic compass that are coupled to the user. When a user enters a building or walks extensively within a facility that has limited GPS reception, for example, pedometer and heading information may be used to determine the location of the user, verifying, adjusting or augmenting previous position or location information from a GPS reading or other personal reference location input. At this point, the GPS unit may be powered down and the personal tracking system powered up to extend battery life.

Pedometer data may be received from a pedometer coupled to the user, as seen at block 310. Pedometer data may comprise, for example, the number of steps taken and the distance between steps. Heading information indicating the geographical direction in which the steps are taken may be received from an electronic compass such as a calibrated magnetometer. The electronic compass may be located, for example, within the pedometer, within an electronic module attachable to a wireless communication device, or within the wireless communication device. The location of the person may be determined based on the pedometer data from the pedometer and the heading information data from the electronic compass. For example, the location of the user is calculated by an algorithm that takes the initial GPS coordinate information and adds the distance corresponding to the number of steps in a geographical direction indicated by the electronic compass heading information. As the user changes location, the position information may be updated. Updates from pedometer data and heading information may be made until, for example, a new personal reference location input is received or valid GPS data becomes available, as seen at block 305.

In cases where a person is indoors and it is desirable to know, for example, the floor where the person is, a barometer may be used to determine the altitude. Altitude information is received from the barometer, as seen at block 315. The barometer may be located, for example, within the pedometer, within an electronic module attachable to a wireless communication device, or within the wireless communication device. The location of the person may be determined based on the altitude information or in combination with other position information from the pedometer or from the GPS unit. After altitude information is received, additional GPS data may be received, as seen at block 305, or additional pedometer data may be received, as sent at block 310, and then position information is determined and updated.

The personal tracking system may be used for personal navigation or for other applications such as tracking by a remote party. In a personal navigation mode, the user sees the location data on the screen or display of the wireless communication device or other digital computing device such as a PDA or a laptop connected to the wireless communication device to aid the user in navigation. In the tracking mode, position or location information may be sent to a server for another party to track the person's location.

When the position information has been determined, a position information message block may be sent from the wireless communication device, as seen at block 320. The position information message block comprises, for example, header information and a message body with one or more fields or entries containing the position information or the determined location. The position information message block may be sent, for example, from a cell phone, a mobile radio, an iDEN phone, or any phone or mobile radio capable of transmitting and receiving packet data. The transmission of the position information message block may be sent, for example, via an IDEN, CDMA, TDMA or GSM phone, or via a wireless LAN (WLAN) operating according to an 802.11b or other suitable wireless protocol.

The position information message block may be received at a server, as seen at block 325. The server may be located, for example, at a central location or at the user's home or office. Alternatively, the position information message block may be forwarded to a user's personal computer, personal digital assistant, or other digital device in proximity to the user or at a remote location with respect to the user. The position information may be stored at a desired location for later downloading or processing. Personal tracking information based on the received position information message block may be updated.

The process may be continued as desired, as seen at block 330. When available, position or location information may be determined from new GPS coordinates or from new pedometer data as seen at block 305 or at block 310. Position information may be updated when changes in altitude are detected, as seen at block 315.

While the embodiments of the invention disclosed herein are presently preferred, various changes and modifications can be made without departing from the spirit and scope of the invention. The scope of the invention is indicated in the appended claims, and all changes that come within the meaning and range of equivalents are intended to be embraced therein.

1. A personal tracking system, comprising:
a wireless communication device;
a pedometer electrically coupled to the wireless communication device; and
an electronic compass operably positioned with respect to the pedometer, wherein readings from the pedometer and the electronic compass are received by the wireless communication device to provide position information.

2. The system of claim 1 wherein the wireless communication device comprises one of a cell phone or a mobile radio.

3. The system of claim 1 wherein the pedometer is electrically coupled to the wireless communication device via a wired or wireless link.

4. The system of claim 1 wherein the pedometer is electrically coupled to the wireless communication device in accordance with a protocol selected from the group consisting of: an IEEE 802.15.4 wireless protocol, and IEEE 802.11 wireless protocol, and a short-range wireless communication protocol.

5. The system of claim 1 wherein the pedometer comprises at least one single-axis accelerometer.

6. The system of claim 1 wherein the electronic compass is mechanically coupled to one of the wireless communication device or the pedometer.

7. The system of claim 1 further comprising:
a barometer electrically coupled to the wireless communication device, wherein barometric signals are received by the wireless communication device to provide altitude information.

8. The system of claim 1 further comprising:
a GPS unit electrically coupled to the wireless communication device, wherein GPS signals from the GPS unit provide a longitudinal coordinate and a latitudinal coordinate to the wireless communication device.

9. The system of claim 1 further comprising:
a server in communication with the wireless communication device, wherein position information is sent from the wireless communication device to the server in response to a position request.

10. A method of tracking a location of a person, comprising:
receiving pedometer data from a pedometer;
receiving heading information from an electronic compass;
determining the location of the person based on the pedometer data and the heading information; and
sending a position information message block from a wireless communication device, the position information message block comprising the determined location.

11. The method of claim 10 wherein the position information message block is sent from one of a cell phone or a mobile radio.

12. The method of claim 10 further comprising:
receiving altitude information from a barometer; and
determining the location of the person based on the altitude information.

13. The method of claim 10 further comprising:
receiving a personal reference location input; and
determining the location of the person based on the personal reference location input.

14. The method of claim 10 further comprising:
receiving GPS coordinate information; and
determining the location of the person based on the GPS coordinate information.

15. The method of claim 10 further comprising:
receiving the position information message block at a server; and
updating personal tracking information based on the received position information message block.

16. A system for tracking a location of a person, comprising:
means for receiving pedometer data from a pedometer;
means for receiving heading information from an electronic compass;
means for determining the location of the person based on the pedometer data and the heading information; and
means for sending a position information message block from a wireless communication device, the position information message block comprising the determined location.

17. The system of claim 16 further comprising:
means for receiving altitude information from a barometer; and
means for determining the location of the person based on the altitude information.

18. The system of claim 16 further comprising:
means for receiving a personal reference location input; and
means for determining the location of the person based on the personal reference location input.

19. The system of claim 16 further comprising:
means for receiving GPS coordinate information; and
means for determining the location of the person based on the GPS coordinate information.

20. The system of claim 16 further comprising:
means for receiving the position information message block at a server; and
means for updating personal tracking information based on the received position information message block.

21. An electronic module for a personal tracking system, comprising:
a controller;
a wireless transceiver operably connected between the controller and a pedometer;
an electronic compass electrically coupled to the controller; and
a wired connection to allow interfacing with a wireless communication device, wherein position information is determined based on readings from the pedometer and the electronic compass, and wherein position information is provided to the wireless communication device via the wired connection.

22. The module of claim 21 wherein the electronic compass is electrically coupled to the controller via one of a wired or a wireless link.

23. The module of claim 21 wherein the wireless communication device comprises one of a cell phone or a mobile radio.

24. The module of claim 21 wherein the wireless transceiver is operably connected to the pedometer in accordance with an IEEE 802.15.4 wireless protocol.

25. The module of claim 21 further comprising:
a barometer electrically connected to the controller, wherein altitude information is determined based on barometric signals from the barometer.

26. The module of claim 21 further comprising:
a GPS unit electrically coupled to the controller, wherein GPS signals from the GPS unit provide a longitudinal coordinate and a latitudinal coordinate to the controller.
